(19) United States
(12) Patent Application Publication
(10) Pub. No.: US 2010/0176158 A1
(43) Pub. Date: Jul. 15, 2010

(54) DOSING DEVICE FOR FLUID PRODUCTS

(75) Inventor: Lamberto Carta, Pescara (IT)

Correspondence Address: YOUNG & THOMPSON, 209 Madison Street, Suite 500, Alexandria, VA, 22314, US

(73) Assignee: EMSAR S.P.A., San Giovanni Teatino (CH) (IT)

(21) Appl. No.: 12/601,859

(22) PCT Filed: May 22, 2008
(86) PCT No.: PCT/IT2008/000342

§ 371 Date: Nov. 25, 2009

(30) Foreign Application Priority Data
May 25, 2007 (IT) RM2007A000288

(51) Int. Cl. G01F 11/00

(52) U.S. Cl. 222/321.9

(57) ABSTRACT

A fluid dosing device includes a substantially hollow main body, fully insertable into a container for a fluid; a piston slidably movable in the main body defining, in combination with the main body, a dosing chamber presenting a containment volume for the fluid product having a capacity defined by the relative position between the piston and the main body; a stem operatively active on the piston to actuate the piston is slidably movable between a first operative position a greatest volume of the dosing chamber and a second operative position with smallest dosing chamber volume; the stem being hollow and in fluid communication with the dosing chamber to expel a portion of fluid. The main body includes a tubular portion connected to a closing ring proximal the upper end of the main body; the closing ring further including a sleeve encompassing the stem and in sliding contact therewith.

### TECHNICAL FIELD

The present invention relates to a dosing device for fluid products. In particular, the present invention relates to a device for dosing and dispensing viscous fluids, such as liquid soaps, lotions or the like.

### BACKGROUND ART

Known dosing devices for fluid products are screwed onto a container containing the fluid to be dispensed, and therefore they also serve as closing caps for said containers.

In known devices, there is a dosage chamber with variable volume in which a portion of fluid is aspirated and, subsequently, expelled. Said chamber is at least partly defined by a cylindrical main body superiorly delimited by an annular shaped closing element, stably connected thereto.

Known devices comprise a movable piston that defines a movable wall of the chamber. In other words, the motion of the piston determines the variation of the volume of the chamber. Usually, the piston is actuated by a hollow rod connected directly to the piston, and slidable in a hole drilled in the closing ring. During use, the lowering of the hollow rod allows the piston to reduce the volume of the chamber and, with the generated overpressure, to then expel the fluid contained therein through the hollow rod and a dispensing head connected to the rod. The subsequent rising of the hollow rod causes an increase in the volume of the chamber and a consequent vacuum that aspirates an additional portion of product into the chamber from the container.

More in detail, once the hollow rod is lowered, a return spring, active between the main body and the rod itself, raises the rod again to a fully raised position. To regulate the flow of fluid within the chamber, a valve is positioned in proximity to a bottom portion of the device which prevents or allows the access of the fluid from the container to the chamber.

Said valve is generally constituted by a ball, housed in a seat of the lower portion of the device. The vacuum generated during the step of loading the portion of fluid lifts the ball, allowing the fluid to enter the chamber. During the expulsion of the product, the ball is kept lowered by the overpressure, preventing the return of the fluid into the container.

Typically, known devices also comprise means to immobilise the hollow rod to prevent involuntary actuations of the rod with the consequent escape of the product.

Said means comprise appendages obtained at the rod which, when the rod is rotated, are inserted into seats obtained on a collar integral with the main body. it is possible to prevent relative movements between the rod and the main body, in the so-called “stop” position.

The device further comprises an internally threaded ring nut, which enables to apply said device to the neck of a container. Disadvantageously, in known devices for dosing fluid products used under a stream of flowing water, e.g. when the device is used in a shower or in a bathtub, it is frequent for a portion of water to be introduced involuntarily into the device. When this occurs, the product is watered down and its characteristics decay. The involuntary inflow of water into the device is facilitated, during the upward return travel of the rod, by the flow of air that enters by blow-by into the device to re-establish the pressure altered by the withdrawal of the fluid portion. In particular, the water accumulated in proximity to the area where the hollow rod enters into the closing ring can be aspirated into the device.

To overcome this drawback, devices have been proposed which reduce the access of water into the device by means of appropriate conformations of the dispenser that serves as a sort of umbrella, thereby limiting the access of water to the internal components of the device. However, such a solution, in addition to not being particularly effective, determines a marked increase in the size of the device, and imposes considerable constraints to the aesthetic forms of the components.

A further disadvantage inherent to prior art devices relates to the valve that allows the portion of fluid product to enter the dosing chamber. The balls used enable a limited passage of product and do not allow high transit speeds. Moreover, once the dispensing of a portion of fluid product is concluded, a part thereof that remains in the dispensing head can fall outside by gravity. Some prior art devices comprise aspirating means that enable to aspirate towards the dosing chamber a reduced portion of product still present in the dispensing head. Said means usually comprise mechanisms that act on the piston to delay its closure at the time of the upwards return of the rod. The sliding of the piston of the rod, respectively in the open and closed position, is forced by appropriate abutments obtained on the inner surface of the main body. The exchanged forces are transmitted on the rod and on the dispensing pushbutton, thus being unpleasantly perceived by the user.

### DISCLOSURE OF INVENTION

An object of the present invention is therefore to overcome the aforementioned drawbacks.

In particular, an object of the present invention is to propose a device for dosing fluid products in which the undesired infiltration of water into the device is prevented, without increasing the size of the device.

An additional object of the present invention is to propose a device for dosing fluid products in which the residues of product that escape from the dispensing head after the operation of the device are recalled into the head in order to prevent the possible dripping of the product or the drying thereof as a result of prolonged contact with air.

Lastly, an object of the present invention is to propose device for dosing fluid products in which the filling of the dosing chamber is rapid and efficient. These objects and others besides, which shall become more readily apparent in the description that follows, are achieved by a device for dosing fluid products comprising the characteristics expressed in claim 1 and in the claims that depend thereon.

### DESCRIPTION OF THE DRAWINGS

Additional characteristics and advantages shall become more readily apparent from the detailed description of a preferred, but not exclusive, embodiment of a device for dosing fluid products according to the present invention.

Said description shall be provided below with reference to the accompanying drawings, provided solely by way of non limiting indication, in which:

FIG. 1 shows a lateral sectioned view of a device for dosing fluid products according to the present invention in a first operative configuration.

FIG. 2 shows a lateral sectioned view of the device of FIG. 1 in a second operative configuration;—FIGS. 3, 4 and 5 show lateral section views of three details of the device of FIG. 1.

### DESCRIPTION OF THE ILLUSTRATIVE EMBODIMENT

With reference to the aforementioned figures, a device for dispensing fluid products according to the present invention is indicated in its entirety with the number 1.

The device 1 comprises a main body 2 that presents a first lower end 2a, entirely contained in a container for a fluid product such as, by way of example, liquid soap, lotion or the like.

The main body 2 comprises a tubular portion 3 with substantially cylindrical shape and a base portion 4, appropriately shaped and comprising a joint 5 to engage a drawing tube (not shown in the figures) to allow the withdrawal of the product from the container.

In detail, the base portion 4 is connected to the tubular portion 3 in proximity to a first lower end 3a thereof. The base portion 4 and the tubular portion 3 are made in one piece. The main body 2 is substantially hollow and it presents a hole 6 obtained on the tubular portion 3 to allow the transit of air towards the container to balance the internal pressure.

The main body 2 contains within it a piston 7, movable slidably relative to the main body 2 (FIG. 4). In detail, the piston 7 defines, in combination with the main body 2, a dosing chamber 8 for a portion of the fluid product.

In particular, the dosing chamber 8 is distinguished by a containment volume whose capacity is a function of the relative position between the piston 7 and the main body 2. In other words, the dosing chamber 8 has variable volume and the piston defines a movable wall 9 of said chamber 8.

The device 1 further comprises a stem 10 operatively active on the piston 7 to actuate it. Consequently, the piston 7 is able to translate to a limited extent relative to the stem 10 along a longitudinal axis “A” of the device 1.

More specifically, the piston 7 has annular shape and it comprises a support band 12 having substantially cylindrical shape connected by means of its annular appendage 13, in proximity to a first end 12a thereof, to the stem 10.

From a second end 12b, opposite to the first 12a, of the band 12 there develops a first cone frustum band 14 separating from the longitudinal axis “A” and a second cone frustum band 15 separating from the axis “A”.

An additional band 16 of substantially cylindrical shape is connected to the first cone frustum band 14 and laps the main body 2 during the displacement of the piston 7.

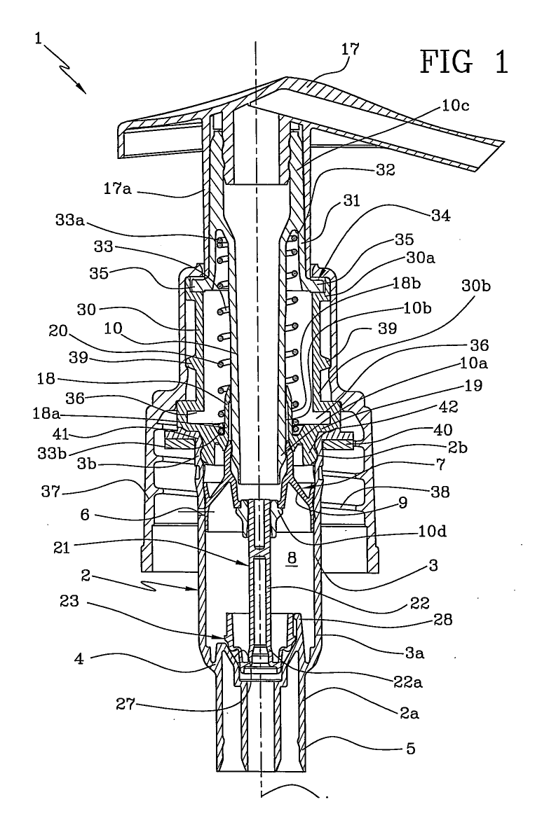

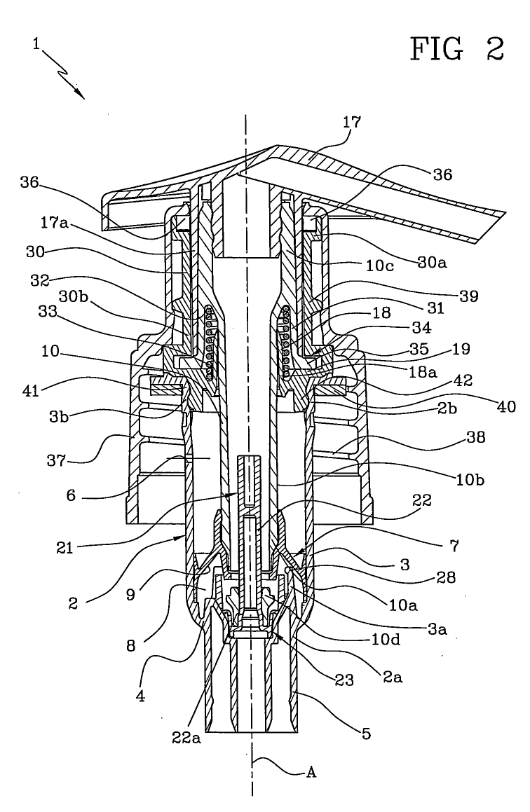

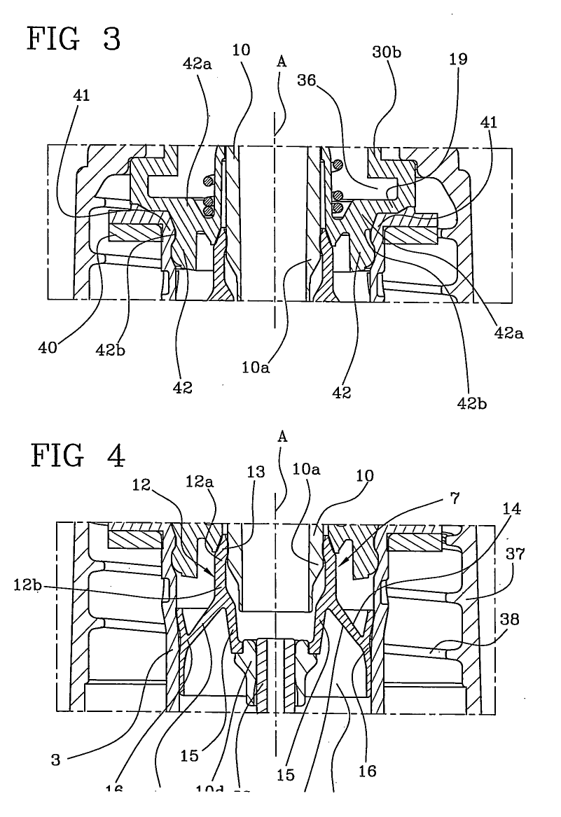

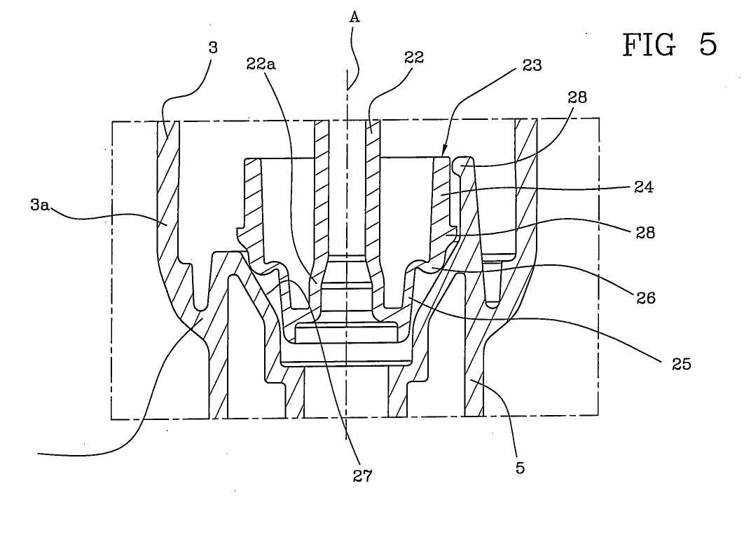

The stem 10 is slidably movable between a first operative position (FIG. 1) in which the volume of the dosing chamber 8 is greatest and a second operative position (FIG. 2) in which the volume of the dosing chamber 8 is smallest.

In other words, in the first operative position the stem 10 is in raised position, whilst in the second operative position is in lowered position.

Moreover, the stem 10 is internally hollow and it is in fluid communication with the dosing chamber 8 to allow the expulsion of the portion of fluid product contained in the chamber 8.

The actuation of the stem 10 determines the change in the volume of the dosing chamber 8. More specifically, when a user lower the stem 10, the volume of the dosing chamber 8 is consequently reduced, the pressure in its interior increases and the portion of fluid contained is thrust into the stem 10 and it is expelled from the device 1 through a dispensing head 17. Said head is connected in proximity to an upper second end 10c of the stem and it preferably presents ergonomic shape, because the user acts on the stem 10 pressing the dispensing head 17. In detail, the dispensing head 17 comprises an outer band 17a which, when the dispensing head 17 is coupled to the stem 10, encompasses the stem in proximity to at least its second upper end 10c.

A closing ring 41 is connected to the main body 2 at its second upper end 2b. In other words, the closing ring 41 is connected to the tubular portion 3 at its second upper end 3b. By way of example, the coupling between the tubular portion 3 and the closing ring 41 can be achieved by rabbet-joining or by screwing (FIG. 3). The closing ring 41 comprises a sleeve 18 having substantially cylindrical shape which encompasses the stem 10 and is in sliding contact therewith. The sleeve 18 is coaxially connected to a tubular segment 30 through a flange 19. In detail, the tubular segment 30 and the sleeve 18 are made in a single piece with the flange 19.

More specifically, the flange 19 is connected to an annular appendage 42, in proximity to its upper end 42a, which extends inferiorly and which is appropriately shaped to obtain a profile 42b that enables the rabbet-joint connection to the second upper end 3b of the tubular portion 3.

The sleeve 18 and the tubular segment 30 are coaxial to the tubular portion 3 and thus to the longitudinal axis “A” of the device 1, and they define a draining canal 20 delimited at least in part by an external surface 18b of the sleeve 18 and by the flange 19. The aforementioned draining channel 20 is also defined by the tubular segment 30. Advantageously, through said channel any infiltrated water can flow outside the device 1.

From the upper second end 10c of the stem 10 develops an external cladding 31 with substantially cylindrical shape coaxial to the stem 10 substantially in the direction of the first lower end 10a of the stem 10.

A spring 33 allows the stem 10 to return to the first operative position after a user has pressed the dispensing head 17 and has brought the stem 10 to the second operative position.

In detail, a first end 33a of the spring 33 is in contact with the flange 19 of the main body 2 and a second end 33b is in contact with an abutment shoulder 32 defined between the cladding 31 and the rest of the stem 10. Consequently, the spring 33 lies externally to the dosing chamber 8.

The device 1 further comprises means 34 for locking the stem 10 in the first or in the second operative position.

In detail, the locking means 34 comprise two tabs 35 obtained on the outer cladding 31 of the stem 10. When the locking means 34 are not active, the tabs 35 slide along slots (not visible in the figures) parallel to the axis “A” and obtained in the tubular segment 30. In this way, the stem 10 is free to move between the first and the second operative position.

When the stem is in the first or in the second operative position, the locking means 34 can be activated by making the stem 10 rotate such that the tabs 35 are housed in respective openings 36 obtained in the tubular segment 30.

In detail, in the described embodiment, there are two openings 36 positioned in proximity to a first upper end 30a of the tubular segment 30 to lock the stem 10 in its first operative position, and two openings 36 obtained in proximity to a second end 30b of the tubular segment 30 to lock the stem 10 in its second operative position.

Advantageously, the device 1 further comprises aspirating means 21 to suck a part of the fluid product that was not dispensed and remained in the dispensing head 17. Said means 21 are active after the dispensing of the portion of fluid product, during the return upwards of the stem 10.

The aspirating means 21 comprise a cursor 22 of substantially cylindrical shape that is inserted into the dosing chamber 8. Said cursor 22 is movable and it can slide along the aforesaid longitudinal axis “A” of the device 1 and it is at least partly inserted in the stem 10. In particular, the cursor 22 is movable relative to the stem 10 and it can move into and out of said stem. Advantageously, the cursor 22 is disengaged from the stem 10. In other words, the cursor 22 is in no way engaged to the stem 10 in the direction of the longitudinal axis “A”.

In use, when the user releases the stem 10 after pressing it and bringing it from the first to the second operative position, the stem 10 is raised, but the cursor 22 tends to remain motionless relative to the stem 10, at least in a first transition step. In this way, the cursor 22 partially exits the stem 10 and the volume contained therein increases generating a small vacuum within the stem 10. The aforesaid vacuum allows to aspirate a small quantity of fluid product from the dispensing head 17 to prevent undesired releases of the product.

The cursor 22 is guided by the stem 10 in the movement along the axis “A”. In other words, the stem 10 also prevents undesired off-axis conditions of the cursor 22.

Since the cursor 22 is free to move relative to the stem 10 in a direction parallel to the axis “A” because there are no hindrances relative to the mutual actuation along the axis “A”, any forces directed parallel to the axis “A” acting on the cursor 22 cannot be transmitted to the stem 10. In other words, the only forces transmissible from the cursor 22 to the stem 10 are directed transversely to the axis “A” and they are not perceptible by the user.

The device 1 also comprises a valve 23 that enables to regulate the entry of the fluid product into the dosing chamber 8 (FIG. 5). In detail, said valve 23 is positioned at the base portion 4 of the main body 2. The valve 23 has substantially cylindrical shape and it is formed by a first cylindrical band 24 and by a second cylindrical band 25, mutually joined by a circular crown 26 substantially perpendicular to the bands 24, 25. More specifically, the first band 24 occupies a greater height and it has greater diameter than the second band 25. The valve thus obtained has the advantage of being sufficiently elastic to partially dampen the thrust that the stem 10 exercises thereon with its terminal portion 10d when the device is in a second operative position. In this position, the stem 10 forces the valve 23 into the closed position to prevent the passage of the product contained in the container and hence its release towards the exterior.

The valve 23 and the cursor 22 are mutually connected. In particular, a lower end 22a of the cursor 22 is connected to the second cylindrical band 25 of the valve 23 through a connecting ring 26a. In detail, the valve 23 is obtained in a single piece with the cursor 22.

The valve 23 is housed in an appropriate seat 27 obtained in the base portion 4 of the main body 2, which is shaped complementarily to the valve 23 in such a way as to allow a sufficient seal when the valve 23 is closed.

The valve 23 is slidably engaged to the base portion 4. In detail, the base portion 4 comprises appendages 28, whereof in the illustrated embodied there are three positioned 120° away from each other, which extend in a direction substantially parallel to the longitudinal axis “A” of the device 1. Said appendages 28 enable a limited translation of the valve 23 (and of the cursor 22) coming in contact with an undercut 29 obtained in proximity of the first band 24 of the valve 23.

The device 1 further comprises a ring nut 37 that presents an internal thread 38 necessary to be coupled to the container. In particular, the ring nut 37 is directly coupled to the tubular segment 30 through appropriate ribs 39 projecting from the tubular segment 30.

A gasket 40 is advantageously positioned under the flange 19 to be interposed between it and the container.

The present invention achieves the proposed objects. First of all, as mentioned above, the sleeve 18 defines, in association with the flange 19 and the tubular segment 30, the draining channel 20 that enables a rapid and effective evacuation of the water that may flow into the ring nut 37. In other words, the draining channel 20 prevents water from accumulating especially in the region where the stem 10 enters the main body 2. In the device 1, the air introduced to restore the internal pressure does not bring any water with it.

Consequently, the device 1 can also be used under a stream of flowing water, without the danger that parts of water may flow into the device 1 and into the container, watering down the fluid product contained therein.

Moreover, the sleeve 18 and the tubular segment 30 that provide the draining channel imply no increase in the size of the device 1. Moreover, the cursor 22 slidably engaged to the base portion 4 enables to aspirate a minimal quantity of fluid product as soon as the dispensing is completed, thereby preventing a drop of product from falling outside the dispensing head 17. Moreover, since said cursor 22 is disengaged from the stem 10, any back-pressure acting on the cursor 22 itself does not impact on the stem 10 and, consequently, on the dispensing head 17. In this way, the user does not perceive any impact or acceleration on the dispensing head 17.

An additional advantage deriving from the device 1 relates to the shape of the valve 23. It has a greater ratio between its surface and its volume than the balls used as valves in prior art devices. Consequently, the valve 23 of the device 1 allows an improved control of the dosage and a greater aspiration speed.

1. A device for dosing fluid products, comprising:—a substantially hollow main body (2), having a lower first end (2a) that can be entirely inserted into a container for a fluid product;
a piston (7) slidably movable in the main body (2) defining, in combination with the main body (2), a dosing chamber (8) having a containment volume for the fluid product having a capacity as a function of the relative position between the piston (7) and the main body (2);
a stem (10) operatively active on the piston (7) to actuate it; the stem (10) being slidably movable between a first operative position in which the volume of the dosing chamber (8) is greatest and a second operative position in which the volume of the dosing chamber (8) is smallest; the stem (10) being hollow and in fluid communication with the dosing chamber (8) to expel a portion of fluid;—a closing ring (41) connected to the main body (2) in proximity to an upper second end (2b) of the main body (2), said closing ring (41) comprising a sleeve (18) encompassing the stem (10) and in sliding contact therewith; said closing ring (41) further comprising a tubular segment (30) connected through a flange (19) to said sleeve (18);
said device being characterised in that an outer surface (18b) of the sleeve (18) and the flange (19) define together with the tubular segment (30) a draining channel (20) positioned around the sleeve (18).

2. Device as claimed in claim 1, wherein said closing ring (41) further comprises an annular appendage (42) connected in proximity to its upper end (42a) to the flange (19); the annular appendage (42) and the sleeve (18) extending in opposite directions relative to the flange (19).

3. Device as claimed in claim 1, wherein the annular appendage (42), the sleeve (18) and the flange (19) are obtained in a single piece.

4. Device as claimed in claim 2, wherein the closing ring (41) is connected to the main body (2) at its annular appendage (42).

5. Device as claimed in claim 1, wherein the closing ring (41) is connected to the main body (2) by rabbet-joining.

6. Device as claimed in claim 1, further comprising aspirating means (21) active during a movement of the stem (10) from the second operative position to the first operative position to aspirate a part of the fluid product not dispensed present in the stem (10).

7. Device as claimed in claim 6, wherein the aspirating means (21) comprise a cursor (22) positioned in the dosing chamber (8) and slidably movable along a longitudinal axis (A) of the device; the cursor (22) being at least in part inserted in the stem (10) and being movable relative thereto to increase the volume contained in the stem (10) during the actuation thereof from its second operative position to its first operative position.

8. Device as claimed in claim 1, further comprising a valve (23) to regulate the inflow of the portion of fluid in the dosing chamber (8).

9. Device as claimed in claim 8, wherein the valve (23) comprises a first (24) and a second cylindrical band (25) joined together by a circular crown (26).

10. Device as claimed in claim 6, further comprising a valve (23) to regulate the inflow of the portion of fluid in the dosing chamber (8), wherein the valve (23) and the cursor (22) are made in a single piece.

11. Device as claimed in claim 8, wherein the main body (2) further comprises a base portion (4); said valve (23) being slidably engaged to said base portion (4) of the main body (2).

12. Device as claimed in claim 11, wherein the base portion (4) comprises an appendage (28); the valve (23) being slidably engaged to the appendage (28).

13. Device as claimed in claim 10, wherein the base portion (4) has a seat (27) to house the valve (23); the seat (27) being shaped complementarily to the valve (23).

14. Device as claimed in claim 1, wherein the tubular segment (30) encompasses at least in part the sleeve (18).

15. Device as claimed in claim 1, wherein the stem (10) further comprises an outer cladding (31), coaxial to the stem (10).

16. Device as claimed in claims 14, further comprising means (34) for locking the stem (10) in its first or second operative position.

17. Device as claimed in claim 16, wherein the locking means (34) comprise at least one tab (38) obtained on the cladding (31) of the stem (10) and engaging in at least one corresponding opening (36) obtained on the tubular segment (30).

18. Device as claimed in claim 2, wherein the annular appendage (42), the sleeve (18) and the flange (19) are obtained in a single piece.

19. Device as claimed in claim 3, wherein the closing ring (41) is connected to the main body (2) at its annular appendage (42).

20. Device as claimed in claim 2, wherein the closing ring (41) is connected to the main body (2) by rabbet-joining.
